(19) United States
(12) Patent Application Publication
(10) Pub. No.: US 2008/0129236 A1
(43) Pub. Date: Jun. 5, 2008

(54) MOTOR CONTROL DEVICE

(75) Inventors: Eiji ISOBE, Kariya-city (JP); Shigeru Kamio, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/941,499

(22) Filed: Nov. 16, 2007

(30) Foreign Application Priority Data
Nov. 30, 2006 (JP) 2006-323063

(51) Int. Cl. H02P 3/06

(52) U.S. Cl. 318/468

(57) ABSTRACT

A control unit learns at least one limit position in a movable range of an object to be controlled which is driven by a motor, and reduces learning time of a limit position. The control unit rotates the motor until the motor strikes the object against at least one limit position in a movable range of the object to learn the limit position. In the strike control, the control unit drives the motor first by a first duty ratio to increase the rotation of the motor toward the limit position quickly, and then by a second duty ratio lower than the first duty ratio to thereby reduce the impact load generated at the time of collision. In place of the duty ratio, a phase advance amount may be changed to reduce the impact load.

### CROSS REFERENCE TO RELATED APPLICATION

This application is based on and incorporates herein by reference Japanese Patent Application No. 2006-323063 filed on Nov. 30, 2006.

### FIELD OF THE INVENTION

The present invention relates to a motor control device that learns at least one limit position of a movable range of an object to be controlled which is driven by a motor.

### BACKGROUND OF THE INVENTION

In recent years, in the automobile field, a mechanical driving system is changed to an electric driving system using an electric motor in order to satisfy requirements of space saving, an improvement in the assembly or an improvement in the controllability.

As one example, as disclosed in U.S. Pat. No. 7,107,869 (JP 2004-308846A), a system is proposed in which a shift range changeover mechanism of an automatic transmission for a vehicle is driven by an electric motor. This system is configured in such a manner that an output shaft is coupled with a rotating shaft of the motor through a reduction mechanism, and the shift range changeover mechanism is driven by the output shaft to change over the shift range of the automatic transmission. In this case, an encoder that detects a rotational position is incorporated into the motor. At the time of changing over the motor, the motor rotates up to a target rotational position (target count value) corresponding to a target shift range on the basis of the count value (encoder count value) of an output pulse of the encoder, thereby changing over the shift range changeover mechanism to the target shift range.

The rotational amount (rotational angle) of the motor is converted into the operational amount of the shift range changeover mechanism through a rotational transmission system such as the reduction mechanism. However, a backlash (looseness) occurs between parts that constitute the rotational transmission system. For example, the looseness (backlash) exists between gears of the reduction mechanism. Also, in the configuration where a joining portion having a noncircular section (square, D-cut configuration) which is formed on a leading end of the rotating shaft of the reduction mechanism is fitted into a fitting hole of the output shaft so that the rotating shaft is coupled with the output shaft, a clearance for facilitating the operation of fitting those shafts to each other is required. In this way, the looseness (backlash) exists in the rotational transmission system that converts the rotational amount (rotational angle) of the motor into the operational amount to be controlled. For this reason, even if the rotational amount of the motor is precisely controlled on the basis of the encoder counter value, an error corresponding to the looseness (backlash) of the rotational transmission system occurs in the operational amount of the shift range changeover mechanism. As a result, it is impossible to control the operational amount of the shift range changeover mechanism with high precision.

Under the above circumstances, there is proposed a system in which a strike control (butting control) that allows the motor to rotate until the motor is struck against the limit position (wall) of the movable range of an object to be controlled (shift range changeover mechanism) is implemented immediately after a motor control system starts up, i.e., after a power supply turns on, as disclosed in U.S. Pat. No. 7,221,116 (JP 2004-23932A). In the system, the limit position is learned as a reference position.

However, the strike control brings the driving force of the motor into a state where the parts of the rotational transmission system are struck against the limit position of the movable range by the aid of the driving force of the motor. For this reason, when the torque or driving velocity of the motor at the time of colliding with the limit position is large, the impact load at the time of colliding with the limit position becomes large. As a result, the possibility that the parts of the rotational transmission system are gradually deformed or damaged becomes higher as the number of strike control executions is increased more, resulting in a reduction in the durability or the reliability.

As countermeasures against the above problem, U.S. Pat. No. 7,221,116 proposes that the phase lead amount of the energizing phase is changed over so as to decrease the torque of the motor or decreasing the driving speed of the motor at the time of executing the strike control.

However, when the torque of the motor is decreased or the driving speed is decreased under the strike control that is implemented immediately after the motor control system starts up as disclosed in U.S. Pat. No. 7,221,116, a time until the motor is struck against the limit position since the strike control starts up is extended. As a result, a time required to learn the limit position is extended, which leads to such a drawback that the operation of changing over an object to be controlled (shift range changeover mechanism) immediately after the motor control system starts up is delayed as much.

### SUMMARY OF THE INVENTION

It is therefore an object of the present invention to provide a motor control device, which is capable of completing strike control or limit position learning in a relatively short time while preventing parts of a rotational transmission system from being deformed or damaged due to the strike control, and is capable of satisfying both of a request for ensuring the durability or reliability of the system and a request for reducing a time required for the limit position learning.

According to one aspect, an electric motor is first driven without lowering the torque of the motor during execution of strike control to increase the rotation of the motor toward a limit position quickly. Thereafter, when the motor comes close to the limit position, the torque of the motor is decreased to decrease the torque at the time of colliding with the limit position, thereby enabling the control for reducing the impact load at the time of collision. As a result, it is possible to complete the strike control (learning of the limit position) in a relatively short time while preventing parts of a rotational transmission system from being deformed or damaged due to the strike control. As a result, it is possible to satisfy both of a request for ensuring the durability or the reliability of the system and a request for reducing a time required for learning the limit position.

In this case, it is preferable to determine a time point to decrease the torque of the motor during the execution of the strike control on the basis of any one of an elapse time since the strike control starts up, the rotational amount of the motor, and the rotational speed. This makes it possible to appropriately set the time point to decrease the torque of the motor during the execution of the strike control.

In general, in order to make an electric motor generate torque in a rotational direction, it is necessary to advance a phase of an energizing coil in the rotating direction, and there is the characteristic that a driving speed of the motor becomes lower as a phase advance amount of the energizing phase is smaller. Taking this characteristic into consideration, it is possible to suppress the driving speed of the motor by reducing the phase advance amount of the energizing phase halfway during the execution of the strike control.

Therefore, according to another aspect, an electric motor is first driven without suppressing a driving speed of the motor during the execution of strike control to increase the rotation of the motor toward a limit position quickly. Thereafter, control can be conducted that the driving speed of the limit position is suppressed down to the rotational speed that is a permissible torque that is determined according to the mechanical strength of respective parts of a rotational transmission system, or lower to reduce the impact load at the time of colliding with the limit position. As a result, it is possible to complete the strike control in a relatively short time while preventing the parts of the rotational transmission system from being deformed or damaged due to the strike control. This makes it possible to satisfy both of a request for ensuring the durability or the reliability of the system and a request for reducing a time required for learning the limit position.

In this case, it is preferable to determine a time point to decrease the phase advance amount of the energizing phase during the execution of the strike control on the basis of any one of an elapse time since the strike control starts up, the rotational amount of the motor, and the rotational speed. This makes it possible to appropriately set when to suppress the driving speed of the motor during the execution of the strike control.

### BRIEF DESCRIPTION OF THE DRAWINGS

The above and other objects, features and advantages of the present invention will become more apparent from the following detailed description made with reference to the accompanying drawings. In the drawings:

FIG. 1 is a perspective view showing a shift range changeover device used in first to sixth embodiments of the present invention;

FIG. 2 is a block diagram schematically showing a control system of the shift range changeover device;

FIG. 3 is a timing chart showing a control example of the first embodiment;

FIG. 4 is a flowchart showing a strike control routine according to the first embodiment;

FIG. 5 is a flowchart showing a strike control routine according to the second embodiment;

FIG. 6 is a flowchart showing a strike control routine according to the third embodiment;

FIG. 7 is a flowchart showing a strike control routine according to the fourth embodiment;

FIG. 8 is a flowchart showing a strike control routine according to the fifth embodiment; and

FIG. 9 is a flowchart showing a strike control routine according to the sixth embodiment.

### DETAILED DESCRIPTION OF THE PREFERRED EMBODIMENTS

### First Embodiment

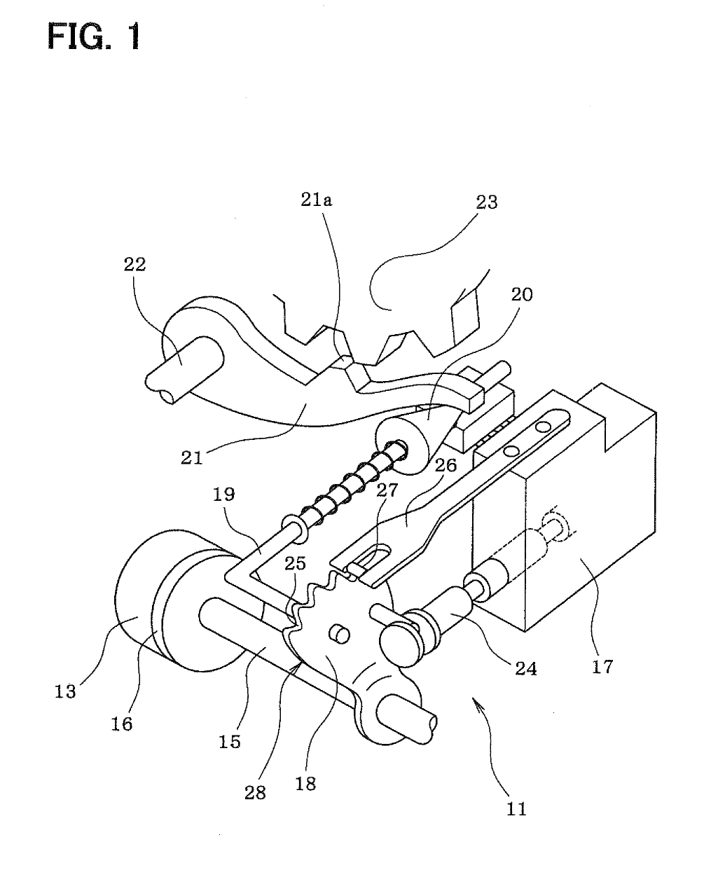

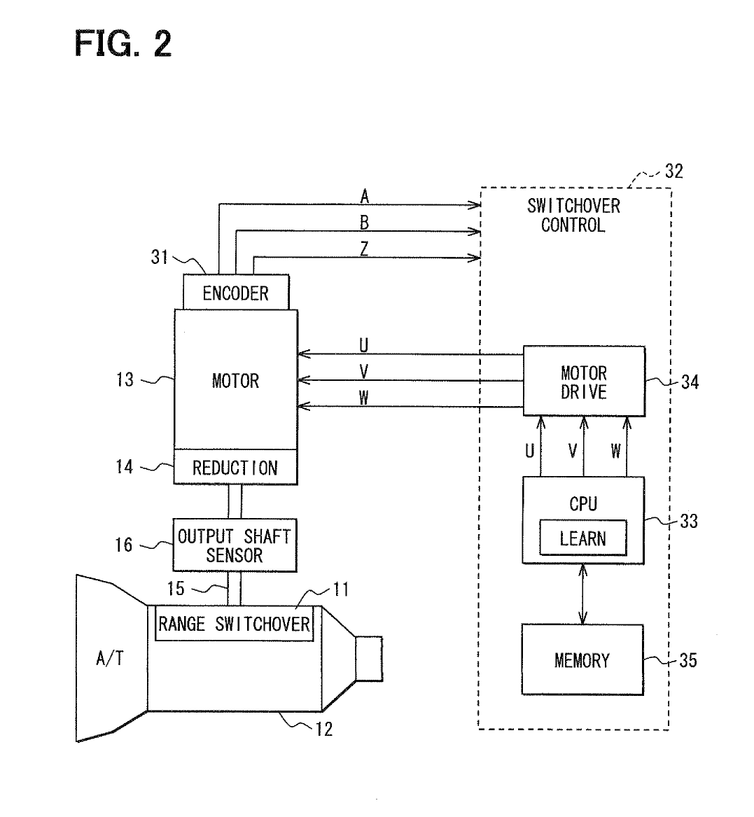

Referring first to FIGS. 1 and 2, a shift range changeover device for an automatic transmission of a vehicle is provided with a shift range changeover mechanism 11. This changeover mechanism 11 is for changing over the shift range of an automatic transmission 12 to, for example, a parking shift range (P), a reverse shift range (R), a neutral shift range (N), or a drive shift range (D). The shift range may be defined as a gear shift position. An electric motor 13 that is a driving source of the shift range changeover mechanism 11 is configured by, for example, a synchronous motor such as a switched reluctance motor (SR motor), and has a reduction mechanism 14 (FIG. 2) incorporated thereinto. An output shaft sensor 16 that detects the rotational position of an output shaft 15 which is coupled with the rotational shaft of the reduction mechanism 14 is disposed at the rotational shaft of the reduction mechanism 14. The output shaft sensor 16 is configured by a switch having four contacts which turn on in a rotational angle shift range corresponding to the respective shift ranges of P, R, N, and D. The output shaft sensor 16 discriminates which contact is in an on-state, to thereby detect the present shift range (output shaft rotational position).

On the other hand, the output shaft 15 is fixed with a detent lever 18 for changing over a manual valve 17 of a hydraulic circuit of the automatic transmission 12. The detent lever 18 is fixed with an L-shaped parking rod 19, and a conical body 20 that is disposed at the leading section of the parking rod 19 is abutted against the lock lever 21. The lock lever 21 is so designed as to vertically move while being centered on the shaft 22 according to the position of the conical body 20 to lock or unlock the parking gear 23. The parking gear 23 is disposed on the output shaft of the automatic transmission 12. When the parking gear 23 is locked by the lock lever 21, the driving wheels of a vehicle are held in a stop state (parking state).

Also, the detent lever 18 is coupled with a spool valve 24 of the manual valve 17. The detent lever 18 is rotated integrally with the output shaft 15 by the aid of the motor 13 to change over the position of the spool valve 24 of the manual valve 17 in such a manner that the hydraulic clutch which is built in the automatic transmission 12 is changed over to any state of the P shift range, the R shift range, the N shift range, and the D shift range.

The detent lever 18 is formed with five retentive recesses 25 for retaining the detent lever 18 to positions corresponding to the respective shift ranges. A leaf detent spring 26 for retaining the detent lever 18 to positions corresponding to the respective shift ranges is fixed to the manual valve 17. An engagement section 27 that is disposed on a leading end of the detent spring 26 is fitted into the retentive recesses 25 of a target shift range of the detent lever 18. As a result, the detent lever 15 is retained at the rotating position of the target shift range, and the position of the spool valve 24 of the manual valve 17 is retained at the position of the target shift range. The detent mechanism 28 is constituted by the detent lever 18, the detent spring 26 and the like.

In the P shift range, the parking rod 19 is moved in a direction of approaching the lock lever 21. A thicker portion of the conical body 20 pushes up the lock lever 21, a convex (projection) 21a of the lock lever 21 is fitted into the parking gear 23 to lock the parking gear 23. With the above operation, the output shaft (driving wheels) of the automatic transmission 12 is held in the locked state (parking state).

In the shift ranges other than the P shift range, the parking rod 19 moves away from the lock lever 21, and the thicker portion of the conical body 20 exits from the lock lever 21, and the lock lever 21 moves down. With the above operation, the convex 21a of the lock lever 21 is disengaged from the parking gear 20 to cancel the lock of the parking gear 20, and the output shaft of the automatic transmission 12 is held in a rotatable state (travelable state).

On the other hand, the motor 13 is equipped with an encoder 31 (motor rotational position detecting means) for detecting the rotational position of a rotor. The encoder 31 is constituted by, for example, a magnetic rotary encoder. The encoder 31 is so designed as to output the pulse signals of an A-phase, a B-phase, and a Z-phase to a shift range changeover control device 32 in synchronism with the rotation of the rotor of the motor 13. A CPU (control means) 33 of the shift range changeover control device 32 counts both of the leading edge and the trailing edge of the A-phase signal and the B-phase signal which are output from the encoder 31. The CPU 33 then changes over the energizing phase of the motor 13 in a given order by means of the motor driving circuit 34 according to the encoder count value, to thereby rotationally drive the motor 13.

In this situation, the CPU 33 determines the rotating direction of the rotor according to the occurrence order of the A-phase signal and the B-phase signal. In the positive rotating direction (the rotating direction from the P shift range to the D shift range), the encoder count value is counted up. In the negative rotating direction (the rotating direction from the D shift range to the P shift range), the encoder count value is counted down. With the above operation, even if the motor 13 rotates in any direction of the positive rotation or the negative rotation, a correspondence relationship between the encoder count value and the rotational position of the motor 13 is maintained. For this reason, in any rotating direction of the positive rotation and the negative rotation, it is possible to detect the rotational position of the motor 13 by the encoder count value to energize a coil winding of a phase corresponding to the rotational position to rotationally drive the motor 13. The Z-phase signal of the encoder 31 is used to detect the reference rotational position of the rotor.

The rotational amount (rotational angle) of the motor 13 is converted into the operational amount (the operational amount of the spool valve 24) of the shift range changeover mechanism 11 through the rotational transmission system including the reduction mechanism 14, the output shaft 15, the detent lever 18, and the like. However, a backlash (looseness) occurs between parts that constitute the rotational transmission system. For example, the backlash exists between gears of the reduction mechanism 14. Also, in the configuration where a joining portion having a noncircular section which is formed on a leading end of the rotating shaft of the motor is fitted into the fitting hole of the output shaft 15 so that the rotating shaft is coupled with the output shaft, a clearance for facilitating the operation of fitting those shafts to each other is required.

Also, when the engagement section 27 of the detent spring 26 is fitted into the respective retentive recesses 25 at the P shift range side or the D shift range side of the detent lever 18, slight clearances (backlashes) exists between the engagement section 27 and the side walls of the respective retentive recesses 25. In this way, the looseness (backlash) exists due to the backlash or the clearances between the parts in the rotational transmission system that converts the rotational amount of the motor into the operational amount of the shift range changeover mechanism 11 (the operational amount of the spool valve 24). For this reason, even if the rotational amount of the motor 13 (rotational angle) is precisely controlled on the basis of the encoder counter value, an error corresponding to the looseness (backlash) of the rotational transmission system occurs in the operational amount of the shift range changeover mechanism 11. As a result, it is impossible to control the operational amount of the shift range changeover mechanism 11 with high precision.

As the countermeasure, according to the first embodiment, in order to learn the limit position (wall position) of the rotatable shift range (movable range) that is regulated by the detent mechanism 28 of the shift range changeover mechanism 11, the following operation is implemented. That is, strike control is implemented after the shift range changeover control device 32 starts up, that is, after the power supply turns on. In the strike control, the motor 13 is made to rotate until the engagement section 27 (part of the rotational transmission system) of the detent spring 26 collides with the side wall of the P shift range retentive recess 25 (or the D shift range retentive recess 25). The P shift range retentive recess (or the D shift range retentive recess) 25 is situated at the P shift range side limit position (or the D shift range side limit position) in the movable range of the shift range changeover mechanism 11. Then, the encoder count value of the limit position (wall position) is stored in the memory 35 as a learning value of a reference position.

However, when the torque (duty ratio) of the motor 13 is larger when the engagement section 27 of the detent spring 26 collides with the limit position, the impact load becomes larger at the time of colliding with the limit position. This leads to the possibility that the parts of the rotational transmission system are gradually deformed and damaged as the number of strike control executions increases, which causes the durability or the reliability to be lowered.

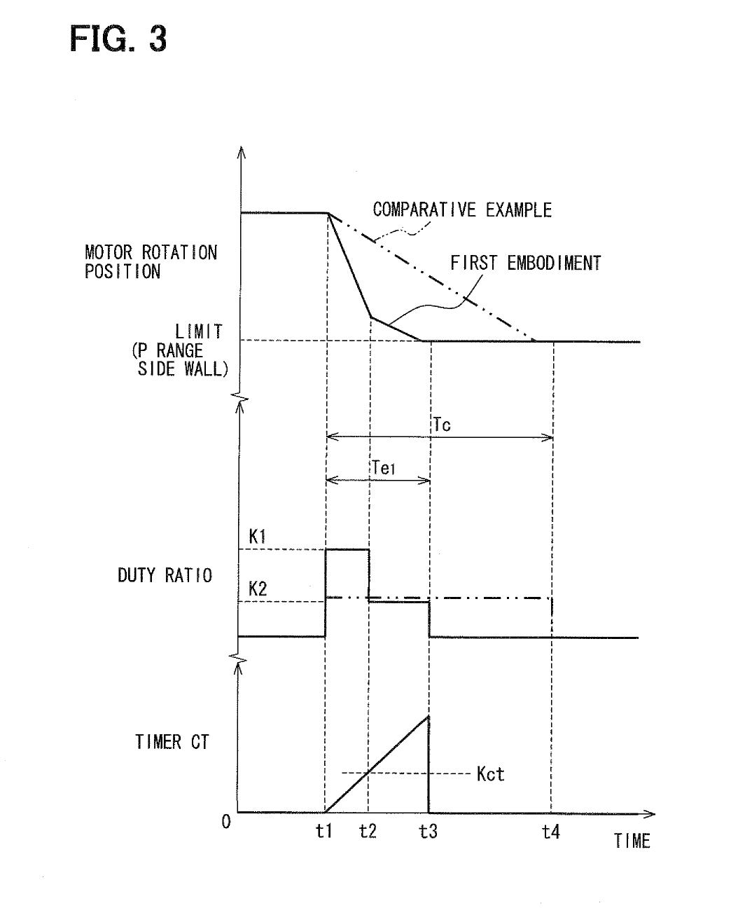

As a countermeasure, as shown in a comparative example indicated by a two-dot chain line in FIG. 3, when the torque (duty ratio) of the motor 13 is lowered from the beginning at the time of executing the strike control, the rotational speed of the motor 13 is decreased. As a result, a time until the engagement section collides with the limit position since the strike control starts, that is, a time required for learning the limit position is extended. This leads to such a drawback that the shift range changeover operation of the shift range changeover mechanism 11 immediately after the shift range changeover control device 32 (immediately after the power supply turns on) starts up is delayed as much.

Under the above circumstance, according to the first embodiment, in order to satisfy both of a request for ensuring the durability or the reliability of the system and a request for reducing a time required for learning the limit position, the energization duty ratio of the motor 13 is reduced halfway during the execution of the strike control to decrease the torque of the motor 13. With the above operation, as indicated by a solid line in FIG. 3, a control can be made that the motor is first driven without lowering the torque (duty ratio) of the motor 13 during the execution of the strike control to increase the rotation of the motor 13 toward the limit position quickly. Thereafter, the duty ratio of the motor 13 is decreased at a position ahead of the collision with the limit position, and the torque of the motor 13 is lowered at the time of colliding with the limit position, to thereby reduce the impact load at the time of collision.

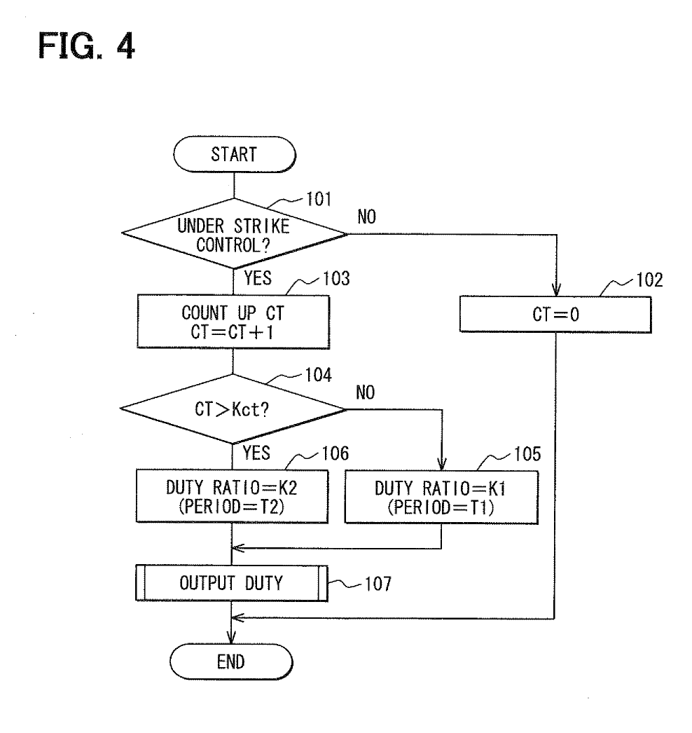

The strike control (a process of learning the limit position) according to the first embodiment described above is executed by the CPU 33 of the shift range changeover control device 32 according to a strike control routine shown in FIG. 4. The strike control routine shown in FIG. 4 is executed in a given cycle while the power is supplied to the shift range changeover control device 32, and functions as learning means.

When the strike control routine shown in FIG. 4 starts, it is checked whether the strike control is being executed, in S (step) 101. When the strike control is not being executed, the processing is advanced to S102 in which a timer CT that counts an elapsed time after the strike control starts up at time t1 is reset to terminate this routine.

On the contrary, when it is determined that the strike control is being executed in S101, the processing is advanced to S103 in which the timer CT is counted up to count the elapsed time after the strike control starts. Then, in subsequent S104, it is checked whether the count value of the timer CT (the elapsed time after the strike control starts) exceeds a given time Kct (=t2−t1), or not. In this example, the given time Kct is set to a time until the engagement section 27 reaches a position ahead of the collision of the engagement section 27 of the detent spring 26 with the limit position. Taking the manufacture tolerance of the respective parts into consideration, the given time Kct is so set as to prevent the engagement section 27 from colliding with the limit position.

When the count value of the timer CT (the elapsed time after the strike control starts up) does not exceed the given time. Kct in S104, the processing is advanced to S105 in which the duty ratio is set to a first duty ratio K1 corresponding to a first on-period T1. The first duty ratio K1 is set to a duty ratio that does not influence the response, for example, a duty ratio that is substantially identical with or larger than the duty ratio of the normal shift range changeover control.

On the contrary, in S104, when the count value of the timer CT (the elapsed time after the strike control starts up) exceeds the given time Kct corresponding to time t2, the processing is advanced to S106 in which the duty ratio is set to a second duty ratio K2 that is lower than the first duty ratio K1. The duty ratio K2 corresponds to a second on-period T2.

As described above, the duty ratio is set to the first duty ratio K1 or the second duty ratio K2 according to the elapsed time after the strike control starts up in the above S105 or S106. Thereafter, the processing is advanced to S107, and the duty output routine (not shown) is executed, and the motor 13 is driven at the first duty ratio K1 or the second duty ratio K2 to execute the control.

The torque of the motor 13 can be lowered in the following manner. That is, the duty cycle is changed over from the first duty cycle T1 to the second duty cycle T2 simultaneously when the duty ratio changes over from the first duty ratio K1 to the second duty ratio K2 during the execution of the strike control. Alternatively, only the duty cycle is changed over from the first duty cycle T1 to the second duty cycle T2 without changing over the duty ratio. This is because when the duty cycle changes, the driving current (driving voltage) of the motor 13 changes, and the torque of the motor 13 changes.

An example of the strike control according to the first embodiment described above will be described with reference to FIG. 3. The duty ratio is set to the first duty ratio K1 that does not influence the response at time t1 when the strike control starts. The motor 13 is driven without lowering the response of the motor 13 to increase the rotation of the motor 13 toward the limit position quickly, to thereby increase the rotational speed of the motor 13. Then, the duty ratio is changed to the second duty ratio K2 that is lower than the first duty ratio K1 at time t2 when the elapsed time (the count value of the timer CT) after the strike control starts reaches the given time Kct, the torque of the motor 13 at the time of colliding with the limit position is lowered, to thereby reduce the impact load at the time of collision. The driving of the motor 13 stops to complete the strike control at time t3 where it is detected to stop the rotation of the motor 13 due to the collision (encoder count value is not changed).

According to the first embodiment described above, the following control is executed. That is, the motor 13 is first driven without lowering the torque (duty ratio) of the motor 13 during the execution of the strike control to increase the rotation of the motor 13 toward the limit position quickly. Thereafter, the duty ratio of the motor 13 is decreased at a position ahead of the collision with the limit position, and the torque of the motor 13 is lowered at the time of colliding with the limit position, to thereby reduce the impact load at the time of collision. For this reason, it is possible to complete the strike control (learning of the limit position) in a relatively short time period Tel relative to a time period Tc of the comparative example, while preventing the parts of the rotational transmission system from being deformed or damaged due to the strike control. This makes it possible to satisfy both of a request for ensuring the durability or the reliability of the system and a request for reducing a time required for learning the limit position.

### Second Embodiment

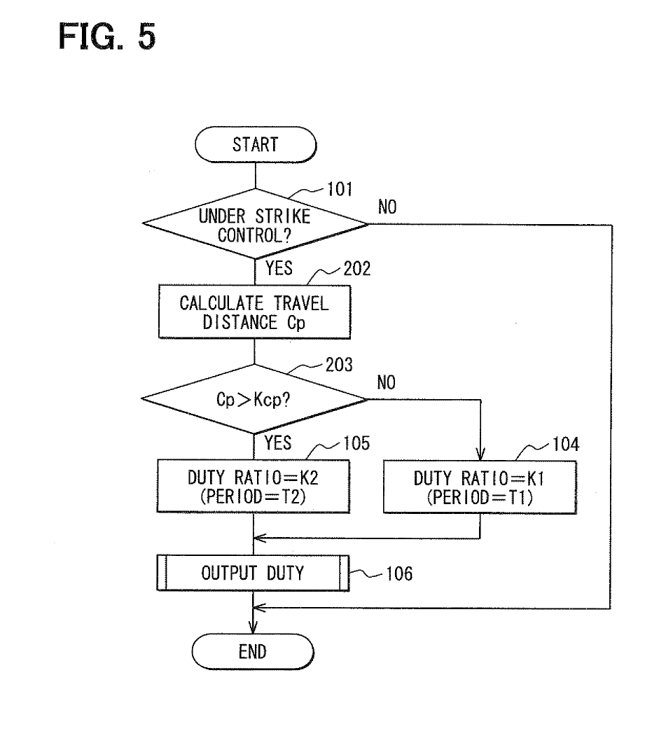

In the first embodiment, when to lower the torque (duty ratio) of the motor 13 during the execution of the strike control is determined on the basis of the elapsed time (the count value of the timer CT) after the strike control starts. In the second embodiment, the strike control routine shown in FIG. 5 is executed to determine when to lower the torque (duty ratio) of the motor 13 during the execution of the strike control is determined on the basis of a travel distance Cp (the rotational amount of the motor 13) after the strike control starts.

In the strike control routine that is executed in the second embodiment in FIG. 5, it is first checked in S101 whether the strike control is being executed. When the strike control is not being executed, this routine is completed as it is.

On the contrary, when it is determined that the strike control is being executed in S101, the processing is advanced to S202 in which the travel distance Cp (the rotational amount of the motor 13) after the strike control starts is converted into the variation of the encoder count value after the strike control starts, and calculated.

Thereafter, the processing is advanced to S203, and it is checked whether the travel distance Cp (the rotational amount of the motor 13) after the strike control starts exceeds a given distance Kcp, or not. In this situation, the given distance Kcp is converted into the variation of the encoder count value until the engagement section 27 of the detent spring 26 reaches a position ahead of the collision with the limit position, and set. The given distance Kcp is so set as to prevent the engagement section 27 from colliding with the limit position taking the manufacture tolerance of the respective parts into consideration.

When it is determined in S203 that the travel distance Cp after the strike control starts does not exceed the given distance Kcp, the processing is advanced to S104, and the duty ratio is set to the first duty ratio K1 that does not influence the response.

On the contrary, when it is determined in S203 that the travel distance Cp after the strike control starts exceeds the given distance Kcp, the processing is advanced to S105, and the duty ratio is set to the second duty ratio K2 that is lower than the first duty ratio K1.

As described above, in the above S104 or S105, the duty ratio is set to the first duty ratio K1 or the second duty ratio K2 according to the travel distance Cp after the strike control starts. Thereafter, the processing is advanced to S106, and the duty output routine (not shown) is executed. Then, the motor 13 is driven at the first duty ratio K1 or the second duty ratio K2 to execute the strike control.

Similarly, in the second embodiment, the torque of the motor 13 is lowered in the following manner. That is, the duty cycle is changed over from the first duty cycle T1 to the second duty cycle T2 simultaneously when the duty ratio changes over from the first duty ratio K1 to the second duty ratio K2 during the execution of the strike control. Alternatively, only the duty cycle is changed over from the first duty cycle T1 to the second duty cycle T2 without changing over the duty ratio to lower the torque of the motor 13.

The same advantages as those in the first embodiment can be obtained in the second embodiment described above.

### Third Embodiment

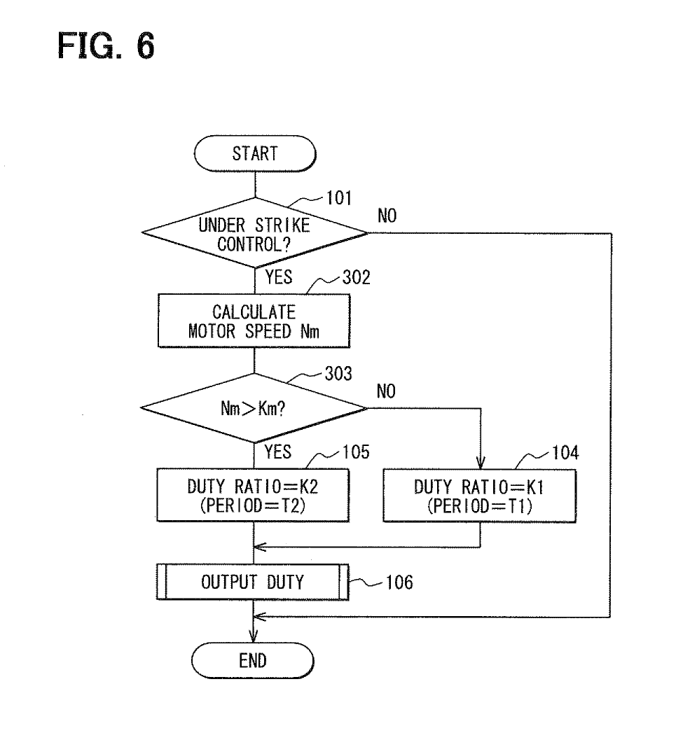

In a third embodiment, the strike control routine shown in FIG. 6 is executed to determine when to lower the torque (duty ratio) of the motor 13 during the execution of the strike control on the basis of the rotational speed Nm of the motor 13.

In the strike control routine that is executed in the third embodiment in FIG. 6, it is first checked in S101 whether the strike control is being executed, and when the strike control is not being executed, this routine is completed as it is.

On the contrary, when it is determined that the strike control is being executed in S101, the processing is advanced to S302 in which the rotational speed Nm of the motor 13 at that time is calculated on the basis of the intervals (cycle) of pulses that are output from the encoder 31.

Thereafter, the processing is advanced to S303, and it is checked whether the rotational speed Nm of the motor 13 exceeds a given rotational speed Km, or not. In this situation, the given rotational speed Km is set to a rotational speed at which the collision torque when the engagement section 27 of the detent spring 26 collides with the limit position is equal to or lower than a permissible torque which is determined according to the mechanical strengths of the respective parts in the rotational transmission system.

When it is determined in S303 that the rotational speed Nm of the motor 13 does not exceed the given rotational speed Km, the processing is advanced to S104, and the duty ratio is set to the first duty ratio K1 that does not influence the response.

On the contrary, when it is determined in S303 that the rotational speed Nm of the motor 13 exceeds the given rotational speed Km, the processing is advanced to S105, and the duty ratio is set to the second duty ratio K2 that is lower than the first duty ratio K1.

As described above, in the above S104 or S105, the duty ratio is set to the first duty ratio K1 or the second duty ratio K2 according to the rotational speed Nm of the motor 13. Thereafter the processing is advanced to S106, and the duty output routine (not shown) is executed. Then, the motor 13 is driven at the first duty ratio K1 or the second duty ratio K2 to execute the strike control.

Similarly, in the third embodiment, the torque of the motor 13 is lowered in the following manner. That is, the duty cycle is changed over from the first duty cycle T1 to the second duty cycle T2 simultaneously when the duty ratio changes over from the first duty ratio K1 to the second duty ratio K2 during the execution of the strike control. Alternatively, only the duty cycle is changed over from the first duty cycle T1 to the second duty cycle T2 without changing over the duty ratio to lower the torque of the motor 13.

The same advantages as those in the first embodiment can be obtained in the third embodiment described above.

When an increase in the rotational speed Nm of the motor 13 is suppressed by a decrease in the battery voltage (supply voltage) or an increase in the frictional resistance of the rotational transmission system, the rotational speed Nm of the motor 13 is likely not to exceed the given rotational speed Km to the end. In this case, the strike control is implemented without lowering the duty ratio to the end. Even with the above operation, the collision torque (the rotational speed Nm of the motor 13) when the engagement section 27 of the detent spring 26 collides with the limit position is equal to or lower than the permissible torque which is determined according to the mechanical strengths of the respective parts of the rotational transmission system. For this reason, it is possible to prevent the parts of the rotational transmission system from being deformed or damaged due to the strike control. Moreover, in the case where the rotational speed of the motor 13 is lowered due to a decrease in the battery voltage (supply voltage) or an increase in the frictional resistance of the rotational transmission system, and the execution time (a time required to learn the limit position) of the strike control becomes longer than the normal one, the strike control can be executed without lowering the duty ratio to the end. As a result, the execution time (a time required to learn the limit position) of the strike control can be prevented from being further extended due to a reduction in the unnecessary duty ratio.

It is thus possible to determine when to decrease the torque (duty ratio) of the motor 13 during the execution of the strike control on the basis of at least two of an elapse time (the count value of the timer CT) after the strike control starts up, the travel distance Cp (the rotational amount of the motor 13), and the rotational speed Nm of the motor 13 (the determining methods in the above first to third embodiments can be combined together and implemented).

### Fourth Embodiment

In order to make the motor 13 generate the torque in the rotational direction, it is necessary to advance the phase of the coil to be energized in the rotating direction. There is such a characteristic that the driving speed of the motor 13 becomes lower as the phase advance amount of the energizing phase is smaller.

Taking the above characteristic into consideration, in a fourth embodiment, the driving speed of the motor 13 is suppressed by reducing the phase advance amount of the energizing phase halfway during the execution of the strike control.

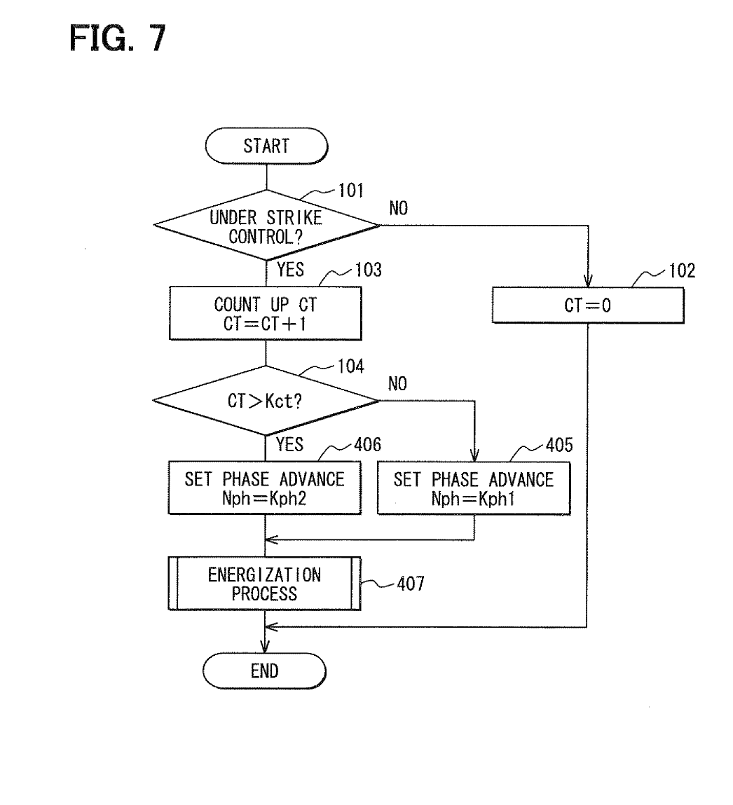

In a strike control routine that is executed in the fourth embodiment shown in FIG. 7, it is first checked in S101 whether the strike control is being executed. When the strike control is not being executed, the processing is advanced to S102 in which the timer CT that counts the elapsed time after the strike control starts is reset, and this routine is completed.

When it is determined that the strike control is being executed in the above S101, the processing is advanced to S103 in which the timer CT counts up, and counts the elapsed time after the strike control starts. Then, in the subsequent S104, it is checked whether the count value (the elapsed time after the strike control starts) of the timer CT exceeds the given time Kct that is set in the same method as that in the above first embodiment or not. When the count value of the timer CT does not exceed the given time Kct, the processing is advanced to S405, and the phase advance amount Nph of the energizing phase is set to the first phase advance amount Kph1. The first phase advance amount Kph1 is set to a phase advance amount that is identical with or larger than the phase advance amount of the normal shift range changeover control.

On the contrary, when it is determined in S104 that the count value (the elapsed time after the strike control starts) of the timer CT exceeds the given time Kct, the processing is advanced to S406, and the phase advance amount Nph of the energizing phase is set to the second phase advance amount Kph2 that is smaller than the first phase advance amount Kph1.

As described above, in the above S405 or S406, the phase advance amount Nph of the energizing phase is set to the first phase advance amount Kph1 or the second phase advance amount Kph2 according to the elapsed time after the strike control starts. Thereafter, the processing is advanced to S407 and the energization processing routine (not shown) is executed. Then, the energizing phase of the motor 13 is changed over at an energizing phase changeover timing corresponding to the phase advance amount Nph of the energizing phase to execute the strike control.

In the fourth embodiment described above, the following control is executed. That is, the motor 13 is first driven without suppressing the driving speed of the motor 13 during the execution of the strike control to increase the rotation of the motor 13 toward the limit position quickly. Thereafter, after the parts of the rotational transmission system approach the limit position, the driving speed of the motor 13 is suppressed to a rotational speed that is equal to or lower than a permissible torque which is determined according to the mechanical strengths of the respective parts of the rotational transmission system. For this reason, it is possible to complete the strike control (learning of the limit position) in a relatively short time while preventing the parts of the rotational transmission system from being deformed or damaged due to the strike control. This makes it possible to satisfy both of a request for ensuring the durability or the reliability of the system and a request for reducing a time required for learning the limit position.

### Fifth Embodiment

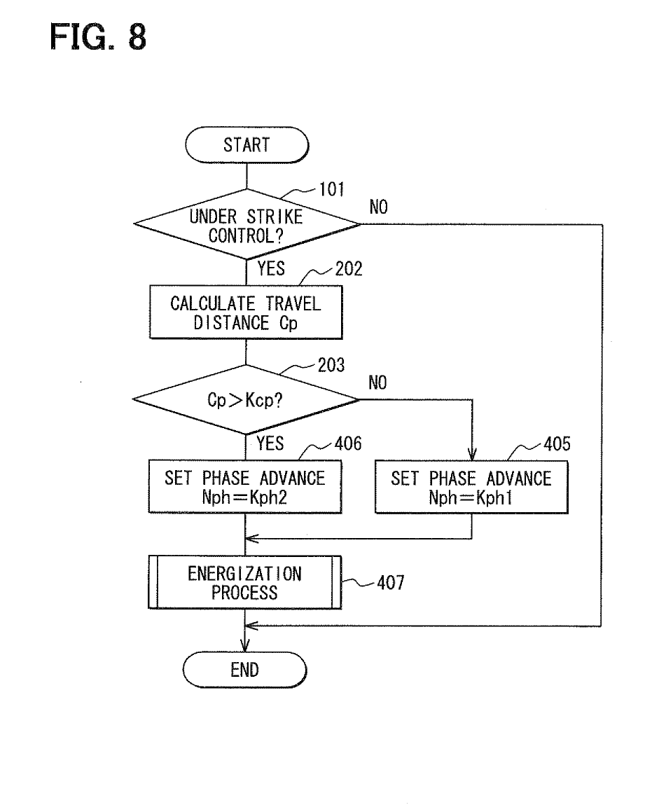

In a fifth embodiment, a strike control routine shown in FIG. 8 is executed to determine when to reduce the phase advance amount Nph of the energizing phase of the motor 13 during the execution of the strike control on the basis of the travel control (the rotational amount of the motor 13) after the strike control starts.

In the strike control routine that is executed in the fifth embodiment in FIG. 8, it is first checked in S101 whether the strike control is being executed. When the strike control is not being executed, this routine is completed as it is.

When it is determined that the strike control is being executed in S101, the processing is advanced to S202 in which the travel distance Cp (the rotational amount of the motor 13) after the strike control starts is converted into the variation of the encoder count value after the strike control starts, and then calculated.

Thereafter, the processing is advanced to S203, and it is checked whether the travel distance Cp (the rotational amount of the motor 13) after the strike control is being executed exceeds a given distance Kcp that is set in the same manner as that of the second embodiment or not. When the travel distance Cp does not exceed the given distance Kcp, the processing is advanced to S405 in which the phase advance amount Nph of the energizing phase is set to the first phase advance amount Kph1. The first phase advance amount Kph1 is identical with or larger than the phase advance amount of the normal shift range changeover control.

On the contrary, when it is determined in S203 that the travel distance Cp after the strike control starts exceeds the given distance Kcp, the processing is advanced to S405, and the phase advance amount Nph of the energizing phase is set to the second phase advance amount Kph2 that is smaller than the first phase advance amount Kph1.

As described above, in the above S405 or S406, the phase advance amount Nph of the energizing phase is set to the first phase advance amount Kph1 or the second phase advance amount Kph2 according to the travel distance Cp after the strike control starts. Thereafter, the processing is advanced to S407, and the energization processing routine (not shown) is executed. Then, the energizing phase of the motor 13 is changed over at an energizing phase changeover timing corresponding to the phase advance amount Nph of the energizing phase to execute the strike control.

The same advantages as those in the fourth embodiment can be obtained in the fifth embodiment described above.

### Sixth Embodiment

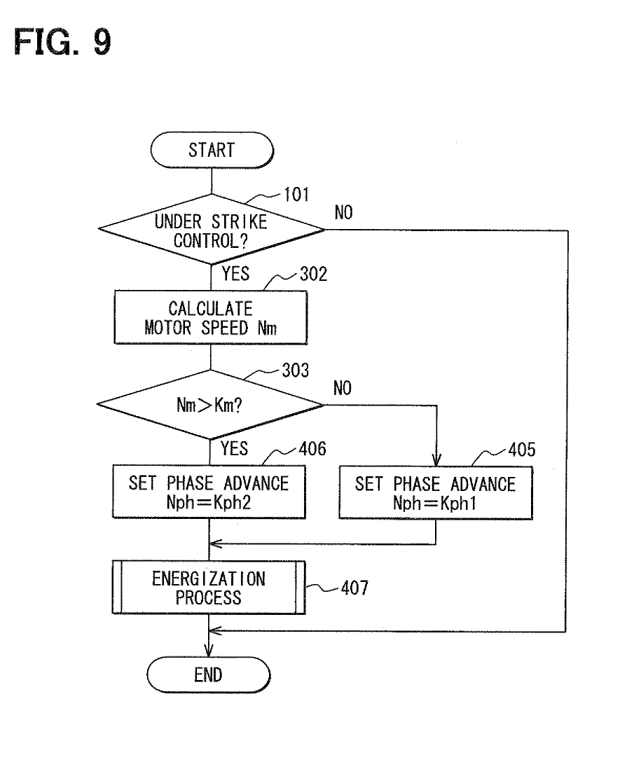

In a sixth embodiment, a strike control routine shown in FIG. 9 is executed to determine when to reduce the phase advance amount Nph of the energizing phase of the motor 13 during the execution of the strike control on the basis of the rotational speed Nm of the motor 13.

In the strike control routine that is executed in the sixth embodiment in FIG. 9, it is first checked in S101 whether the strike control is being executed. When the strike control is not being executed, this routine is completed as it is.

When it is determined that the strike control is being executed in Step 101, the processing is advanced to S302 in which the rotational speed Nm of the motor 13 at that time is calculated on the basis of the intervals (cycle) of the pulses which are output from the encoder 31.

Thereafter, the processing is advanced to S303, and it is checked whether the rotating speed Nm of the motor 13 exceeds a given rotational speed Km that is set in the same manner as that of the third embodiment, or not. When the rotating speed Nm does not exceed the given rotational speed Km, the processing is advanced to S405 in which the phase advance amount Nph of the energizing phase is set to the first phase advance amount Kph1. The first phase advance amount Kph1 is identical with or larger than the phase advance amount of the normal shift range changeover control.

On the contrary, when it is determined that the rotating speed Nm of the motor 13 exceeds the given rotational speed Km, the processing is advanced to S406 in which the phase advance amount Nph of the energizing phase is set to the second phase advance amount Kph2 that is smaller than the first phase advance amount Kph1.

As described above, in the above S405 or S406, the phase advance amount Nph of the energizing phase is set to the first phase advance amount Kph1 or the second phase advance amount Kph2 according to the rotating speed Nm of the motor 13. Thereafter, the processing is advanced to S407, and the energization processing routine (not shown) is executed. Then, the energizing phase of the motor 13 is changed over at an energizing phase changeover timing corresponding to the phase advance amount Nph of the energizing phase to execute the strike control.

The same advantages as those in the sixth embodiment can be obtained in the fourth embodiment described above.

In the present invention, it is possible to determine when to decrease the phase advance amount Nph of the motor 13 during the execution of the strike control on the basis of at least two of an elapse time (the count value of the timer CT), the travel distance Cp (the rotational amount of the motor 13), and the rotational speed Nm of the motor 13, each after the strike control starts up. The methods of determination of the fourth to the sixth embodiments may be combined.

Also, it is possible that the energization duty ratio of the motor 13 is reduced halfway during the execution of the strike control, and the phase advance amount Nph of the energizing phase is reduced.

The encoder (motor rotational position detecting means) used in the present invention is not limited to the magnetic encoder 31, but for example, an optical encoder or a brush encoder may be used.

Also, the motor 13 is not limited to an SR motor, but synchronous motors other than the SR motor may be employed when the rotational position of the rotor is detected on the basis of the encoder count value to sequentially change over the energizing phase.

Also, the shift range changeover device shown in FIG. 1 is so configured as to change over four shift ranges of P, R, N, and D of the automatic transmission in association with the rotating operation of the detent lever 18. However, five or more shift ranges can be changed over. The present invention may be applied to the shift range changeover device that changes over only two shift ranges of the P shift range and another shift range (not P shift range) other than the P shift range.

Also, the present invention may be applied to diverse devices that have the synchronous motor such as the SR motor as the driving source for implementation.

What is claimed is:

1. A motor control device comprising:
rotational position detecting means for detecting a rotational position of a motor that rotationally drives an object to be controlled;
control means for sequentially changing over an energizing phase of the motor according to the rotational position of the motor to rotationally drive the motor to a target position; and
learning means for executing strike control that rotates the motor until the motor strikes the object against at least one limit position in a variable shift range of the object to learn the limit position,
wherein the learning means lowers a torque of the motor in a course of execution of the strike control.

2. The motor control device according to claim 1,
wherein the learning means determines when to decrease the torque of the motor during execution of the strike control on the basis of any one of an elapse time, a rotational amount of the motor, and a rotational speed of the motor, since the strike control starts up.

3. A motor control device comprising:
rotational position detecting means for detecting a rotational position of a motor that rotationally drives an object to be controlled;
control means for sequentially changing over an energizing phase of the motor according to the rotational position of the motor to rotationally drive the motor to a target position; and
learning means for executing strike control that rotates the motor until the motor strikes the object against at least one limit position in a variable shift range of the object to learn the limit position,
the learning means reduces a phase advance amount of the energizing phase in a course of execution of the strike control to suppress a driving speed of the motor.

4. The motor control device according to claim 3,
wherein the learning means determines when to decrease the phase advance amount of the energizing phase during execution of the strike control on the basis of any one of an elapse time, a rotational amount of the motor, and a rotational speed of the motor, since the strike control starts up.
